(19) United States
(12) Patent Application Publication
(10) Pub. No.: US 2026/0064398 A1
(43) Pub. Date: Mar. 5, 2026

(54) SELF-SERVICE REAL-TIME VEHICLE DATA STREAMING

(71) Applicant: FCA US LLC, Auburn Hills, MI (US)

(72) Inventors: Andrew Hoin, Auburn Hills, MI (US); Raghuvirsinh Sodha, Auburn Hills, MI (US)

(21) Appl. No.: 18/820,398

(22) Filed: Aug. 30, 2024

(51) Int. Cl. G06F 8/65; B60R 16/023

(52) U.S. Cl. CPC G06F 8/65; B60R 16/0231

(57) ABSTRACT

A dynamic controller area network database (DBC) configuration and electronic control unit (ECU) signal access system and method for a vehicle each include a controller area network (CAN) of the vehicle and an ECU of the vehicle, the ECU being connected to the CAN and including a DBC defining a plurality of ECU signals that are accessible from the ECU via the CAN, an application layer, and an abstraction layer between the application layer and the DBC, wherein the DBC is configured to be dynamically customized based on a set of desired ECU signals provided by the application layer via the abstraction layer, and wherein the set of desired ECU signals are in addition to the plurality of ECU signals defined by the DBC.

### FIELD

The present application generally relates to accessing vehicle controller area network (CAN) signals and, more particularly, to self-service real-time vehicle data streaming.

### BACKGROUND

Today's vehicles include a plurality of electronic control units (ECUs) in communication via a controller area network (CAN) bus. ECU signals broadcasted on the CAN bus are routinely accessed by vehicle service personnel and other users, such as software application developers. Currently, the conventional solution for users seeking to access additional (i.e., previously inaccessible) ECU signals is to wait for original equipment manufacturers (OEMs) and suppliers to coordinate and release updated CAN bus database (DBC) bundles every few years. This approach relies on intermittent, large-scale updates to grant access to new datasets, rather than providing a method for real-time, on-demand data access. Companies and innovators dependent on broader ECU signal access are thus constrained by the prolonged timeline of infrequent database updates propagated across the automotive industry. Accordingly, while such conventional vehicle DBC access techniques do work for their intended purpose, there exists an opportunity for improvement in the relevant art.

### SUMMARY

According to one example aspect of the invention, a dynamic controller area network database (DBC) configuration and electronic control unit (ECU) signal access system for a vehicle is presented. In one exemplary implementation, the system comprises a controller area network (CAN) of the vehicle and an ECU of the vehicle, the ECU being connected to the CAN and comprising a DBC defining a plurality of ECU signals that are accessible from the ECU via the CAN, an application layer, and an abstraction layer between the application layer and the DBC, wherein the DBC is configured to be dynamically customized based on a set of desired ECU signals provided by the application layer via the abstraction layer, and wherein the set of desired ECU signals are in addition to the plurality of ECU signals defined by the DBC.

In some implementations, the set of desired ECU signals are provided from the application layer to the DBC via the abstraction layer during a previous boot cycle of the ECU and the DBC is dynamically configured for a current boot cycle of the ECU. In some implementations, the DBC is configured to be dynamically customized such that: before the dynamic customization, a first request to the ECU via the CAN for one of the desired ECU signals is filtered or ignored, and after the dynamic customization, a second request to the ECU via the CAN for one of the desired ECU signals is honored or responded to.

In some implementations, the dynamic customization of the DBC is performed by the ECU in response to an update to the application layer from a remote computing device. In some implementations, the remote computing device is an original equipment manufacturer (OEM) computing device associated with an OEM of the vehicle. In some implementations, the remote computing device is a computing device associated with an authenticated or authorized third-party developer. In some implementations, the dynamic DBC provides for access to any desired signal available at the ECU after an application update period. In some implementations, the application update period is shorter than an OEM firmware update period associated with DBC updates.

According to another example aspect of the invention, a dynamic DBC configuration and ECU signal access method for a vehicle is presented. In one exemplary implementation, the method comprises establishing a CAN of the vehicle having an ECU of the vehicle connected thereto, wherein the ECU comprises a DBC defining a plurality of ECU signals that are accessible from the ECU via the CAN, an application layer, and an abstraction layer between the application layer and the DBC, and dynamically customizing the DBC based on a set of desired ECU signals provided by the application layer via the abstraction layer, wherein the set of desired ECU signals are in addition to the plurality of ECU signals defined by the DBC.

In some implementations, the providing of the set of desired ECU signals from the application layer to the DBC via the abstraction layer is performed during a previous boot cycle of the ECU, and the DBC is dynamically configured for a current boot cycle of the ECU. In some implementations, the DBC is configured to be dynamically customized such that before the dynamic customization, a first request to the ECU via the CAN for one of the desired ECU signals is filtered or ignored, and after the dynamic customization, a second request to the ECU via the CAN for one of the desired ECU signals is honored or responded to.

In some implementations, the dynamic customization of the DBC is performed by the ECU in response to an update to the application layer from a remote computing device. In some implementations, the remote computing device is an OEM computing device associated with an OEM of the vehicle. In some implementations, the remote computing device is a computing device associated with an authenticated or authorized third-party developer. In some implementations, the dynamic DBC provides for access to any desired signal available at the ECU after an application update period. In some implementations, the application update period is shorter than an OEM firmware update period associated with DBC updates.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A is a diagram depicting conventional controller area network (CAN) bus database (DBC) signal accessibility for an electronic control unit (ECU) of a vehicle according to the prior art;

FIGS. 1B-1C are diagrams of an ideal or theoretical ECU signal accessibility and an improved ECU signal accessibility via a dynamically configured DBC according to the principles of the present application;

FIGS. 2A-2B are functional block diagrams an example dynamic DBC configuration and ECU signal accessibility system of a vehicle according to the principles of the present application; and

FIG. 3 is a flow diagram of an example dynamic DBC configuration and ECU signal accessibility method for a vehicle according to the principles of the present application.

### DESCRIPTION

As previously discussed, the conventional solution for users seeking to access additional (i.e., previously inaccessible) vehicle electronic control unit (ECU) signals is to wait for vehicle original equipment manufacturers (OEMs) and suppliers to coordinate and release updated controller area network (CAN) bus database (DBC) bundles every few years. This approach relies on intermittent, large-scale updates to grant access to new datasets, rather than providing a method for real-time, on-demand data access. This conventional solution of sporadic, sweeping CBS updates also carries significant drawbacks. The long lag between updates translates to missed opportunities for optimization, customization, and innovation based on emerging ECU capabilities. The batched bundling of signals also prohibits customizable access to specific signals of interest. Additionally, the arduous coordination required across OEMs and suppliers slowed industry-wide adoption of new ECU datasets. This dated model of intermittent access and bundled datasets is thus deficient in responding to users' needs for flexibility, immediacy, and granularity of ECU data access. Accordingly, new and improved DBC configuration and ECU signal access techniques for vehicles are presented herein.

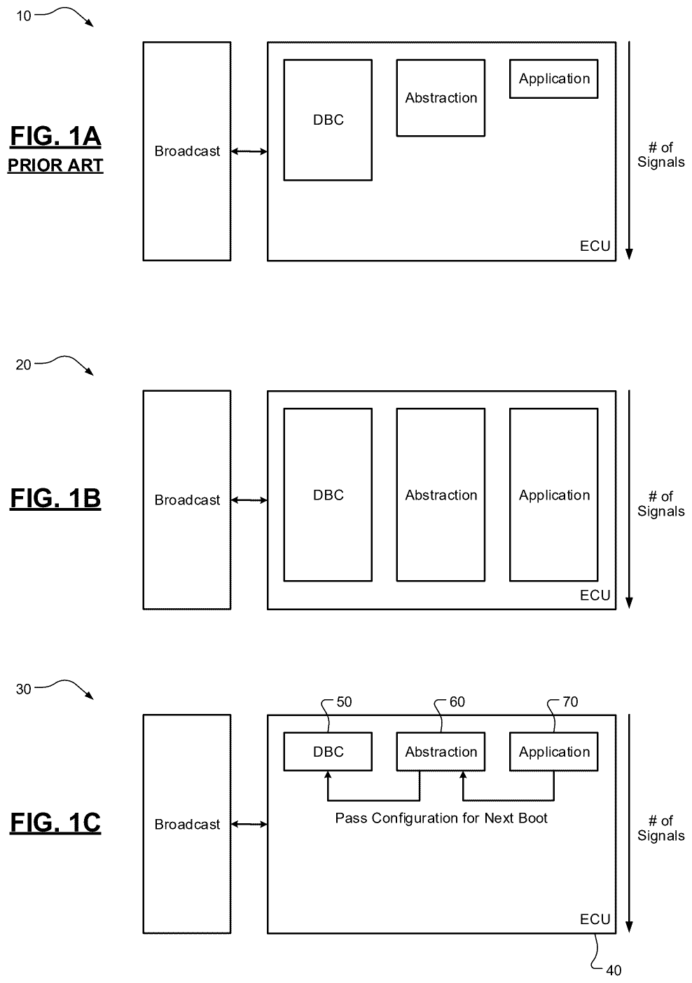

Referring now to FIGS. 1A-1C, diagrams are illustrated depicting (1) conventional DBC signal accessibility for a vehicle ECU according to the prior art (FIG. 1A), (2) an ideal or theoretical ECU signal accessibility (FIG. 1B), and (3) an improved ECU signal accessibility via a dynamically configured DBC according to the principles of the present application (FIG. 1C). The techniques of the present disclosure, illustrated by FIG. 1C, provide for service enabling dynamic configuration of DBCs (e.g., DBC 50) to allow users to programmatically access and leverage any available ECU signals (e.g., for ECU 40) from a vehicle are presented herein. This new approach facilitates configurable settings requests to be transmitted to the DBC from the application layer 70 via the CAN bus abstraction layer 60, empowering utilization of previously inaccessible ECU signals by end users within a minimal timeframe. In other words, the dynamic configurable DBC enables dynamic tapping of ECU signals over the CAN bus through programmatic settings requests mediated by the CAN bus abstraction layer 60. This provides users with on-demand access to a comprehensive range of ECU signals for various vehicle systems, including, but not limited to, powertrain, chassis, body, and active safety controllers. The configurable DBC service satisfies users'needs for immediacy and flexibility in harnessing expanding ECU capabilities as they emerge.

The conventional solution of intermittent, bundled database updates, as described above, is shown in FIG. 1A. While an ideal or theoretical solution where the DBC is unfiltered or non-limited, as shown in FIG. 1B, would be desirable, this approach is not possible due to existing hardware limitations (processing, memory, etc.). This enables immediate access to previously filtered ECU signals without waiting for rigid, predefined update cycles. The configurable DBC interface empowers direct, customized tapping of raw ECU data streams, rather than relying on curated bundles of signals. Specifically, what sets the techniques of the present application apart is its ability to dynamically reprogram CAN bus databases through abstraction layers, circumventing existing barriers to specific, unincorporated ECU signals. By facilitating granular, “just-in-time” access, these techniques liberates ECU data from proprietary silos and static configurations imposed by conventional DBC architectures by circumventing existing limitations of curated DBC signal bundles and avails an extensive palette of raw CAN bus signals to users for prompt utilization. Overall, it opens new possibilities for customization, optimization, and innovation through the flexibility of accessing unincorporated ECU data streams in a just-in-time manner.

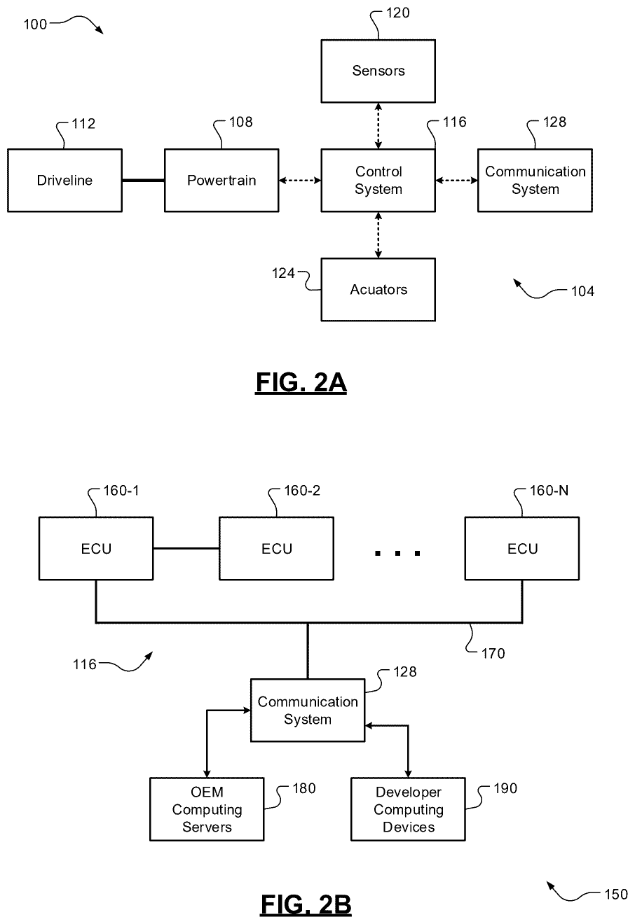

Referring now to FIGS. 2A-2B, functional block diagrams depicting an example vehicle 100 having a dynamic DBC configuration and ECU signal access system 104 and an example configuration 150 of the system 104 are illustrated. The vehicle 100 could have any suitable configuration but, for illustrative/descriptive purposes, the vehicle 100 is shown to generally include a powertrain 108 configured to generate and transfer torque to a driveline 112 for propulsion. Non-limiting examples of the components of the powertrain 108 include an engine, an electric motor, a transmission, and combinations thereof. Non-limiting examples of the components of the driveline 112 include axles or half-shafts, differentials, and wheels. A control system 116 is configured to control operation of the vehicle 100, including receiving measurements from a plurality of sensors 120 and controlling a plurality of actuators or other vehicle systems 124. For example only, the control system 116 could receive a driver torque request via a driver interface or sensor (e.g., an accelerator pedal) and then control the powertrain 108 to generate an amount of drive torque to satisfy the driver torque request. The control system 116 is also configured to communicate with external computing systems via a communication system 128 (e.g., a transceiver) and a network (e.g., a cellular or satellite data network).

In one exemplary configuration 150, the control system 116 comprises a plurality of controllers or ECUs 160-1 . . . 160-N (N being an integer greater than one; collectively, “ECUs 160”) configured to communicate with each other via a CAN 170 comprising one or more CAN buses. For example, the CAN 170 could include a plurality of different CAN buses and each CAN bus could be configured to broadcast a certain set of ECU signals. Non-limiting examples of the ECUs 160 include a supervisory or primary ECU (e.g., a vehicle control unit, or VCU) and subsidiary or secondary ECUs (an engine control unit, or ECU, a motor control unit, or MCU, a transmission control unit, or TCU, etc.). As discussed above, in some cases, the ECU signals broadcast on the CAN 170 are accessed by authenticated external computing devices, such as, but not limited to, OEM computing servers 180 and developer computing devices 190. This access could occur in real-time (e.g., monitoring by the OEM computing servers 180) or could occur periodically, such as in offloaded or downloaded batches of data (e.g., by the developer computing devices 190 for subsequent use). The developer computing devices 190 could be associated with OEM developers or third-party developers having been granted authenticated access.

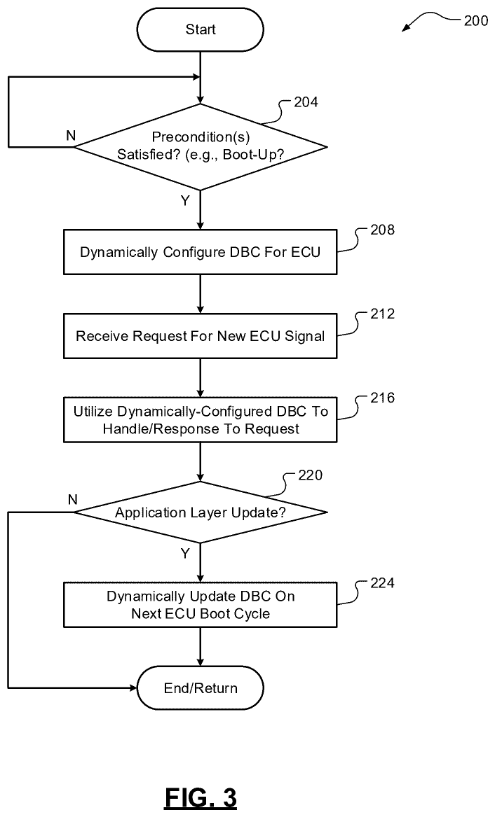

Referring now to FIG. 3 and with continued reference to the previous FIGS., a flow diagram depicting an example dynamic DBC configuration and ECU signal access method 200 for a vehicle according to the principles of the present application is illustrated. While the method 200 specifically references the earlier FIGS. and the previously discussed components (e.g., vehicle 100), it will be appreciated that the method 200 could be applicable to any suitable vehicle and CAN network implementations. The method 200 begins at 204 where it is determined whether a set of preconditions are satisfied. These precondition(s) could include, for example only, the vehicle 100 being powered-up and running (e.g., a bootup of ECU 40) and there being no malfunctions present that would negatively impact or otherwise inhibit the operations of the present application. When false, the method 200 ends or returns to 204. When true, the method 200 proceeds to 208.

At 208, the DBC is dynamically configured based on a desired set of ECU signals. This desired set of ECU signals could be determined, for example, based on respective sets of desired ECU signals passed from the application layer 60 via abstraction layer 70 of the ECU 40 to the DBC 50 of the ECU 40 during a previous boot cycle. At 212, the dynamically configured DBC 50 receives CAN broadcasts (i.e., requests) for ECU signals that would have previously been filtered or inaccessible. At 216, the dynamically configured DBC 50 responds to the CAN broadcasts by broadcasting (via the CAN 170) the ECU signals that were requested. The method 200 then continues for a remainder of the current boot cycle and then ends or returns to 204. During the current boot cycle, however, at optional 220-224, it could be determined whether another dynamic update to the configuration of the DBC 50 is needed or requested (at 220) and, when true, the application layer 70 could be updated and could thereafter request (via the abstraction layer 60) another dynamic configuration of the DBC 50 (at 224) for a next boot cycle (i.e., after returning back to 208).

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A dynamic controller area network database (DBC) configuration and electronic control unit (ECU) signal access system for a vehicle, the system comprising:
a controller area network (CAN) of the vehicle; and
an ECU of the vehicle, the ECU being connected to the CAN and comprising:
a DBC defining a plurality of ECU signals that are accessible from the ECU via the CAN,
an application layer, and
an abstraction layer between the application layer and the DBC,
wherein the DBC is configured to be dynamically customized based on a set of desired ECU signals provided by the application layer via the abstraction layer, and wherein the set of desired ECU signals are in addition to the plurality of ECU signals defined by the DBC.

2. The system of claim 1, wherein the set of desired ECU signals are provided from the application layer to the DBC via the abstraction layer during a previous boot cycle of the ECU and the DBC is dynamically configured for a current boot cycle of the ECU.

3. The system of claim 1, wherein the DBC is configured to be dynamically customized such that:
before the dynamic customization, a first request to the ECU via the CAN for one of the desired ECU signals is filtered or ignored; and
after the dynamic customization, a second request to the ECU via the CAN for one of the desired ECU signals is honored or responded to.

4. The system of claim 1, wherein the dynamic customization of the DBC is performed by the ECU in response to an update to the application layer from a remote computing device.

5. The system of claim 4, wherein the remote computing device is an original equipment manufacturer (OEM) computing device associated with an OEM of the vehicle.

6. The system of claim 4, wherein the remote computing device is a computing device associated with an authenticated or authorized third-party developer.

7. The system of claim 1, wherein the dynamic DBC provides for access to any desired signal available at the ECU after an application update period.

8. The system of claim 7, wherein the application update period is shorter than an OEM firmware update period associated with DBC updates.

9. A dynamic controller area network database (DBC) configuration and electronic control unit (ECU) signal access method for a vehicle, the method comprising:
establishing a controller area network (CAN) of the vehicle having an ECU of the vehicle connected thereto, wherein the ECU comprises:
a DBC defining a plurality of ECU signals that are accessible from the ECU via the CAN,
an application layer, and
an abstraction layer between the application layer and the DBC; and
dynamically customizing the DBC based on a set of desired ECU signals provided by the application layer via the abstraction layer, wherein the set of desired ECU signals are in addition to the plurality of ECU signals defined by the DBC.

10. The method of claim 9, wherein:
the providing of the set of desired ECU signals from the application layer to the DBC via the abstraction layer is performed during a previous boot cycle of the ECU; and
the DBC is dynamically configured for a current boot cycle of the ECU.

11. The method of claim 9, wherein the DBC is configured to be dynamically customized such that:
before the dynamic customization, a first request to the ECU via the CAN for one of the desired ECU signals is filtered or ignored; and
after the dynamic customization, a second request to the ECU via the CAN for one of the desired ECU signals is honored or responded to.

12. The method of claim 9, wherein the dynamic customization of the DBC is performed by the ECU in response to an update to the application layer from a remote computing device.

13. The method of claim 12, wherein the remote computing device is an original equipment manufacturer (OEM) computing device associated with an OEM of the vehicle.

14. The method of claim 12, wherein the remote computing device is a computing device associated with an authenticated or authorized third-party developer.

15. The method of claim 9, wherein the dynamic DBC provides for access to any desired signal available at the ECU after an application update period.

16. The method of claim 15, wherein the application update period is shorter than an OEM firmware update period associated with DBC updates.
